(19) United States
(12) Patent Application Publication
(10) Pub. No.: US 2007/0288884 A1
(43) Pub. Date: Dec. 13, 2007

(54) MANAGING NON-ESSENTIAL FORMATTING ELEMENTS PECULIAR TO INDIVIDUAL PROGRAM DEVELOPERS IN SOURCE CODE IN A SYSTEM FOR SHARED COMPUTER PROGRAM DEVELOPMENT

(76) Inventors: VINCE CARL BRUNSSEN, ROUND ROCK, TX (US); ANDREW DOUGLAS HATELY, AUSTIN, TX (US); MERLE DOUGLAS STERLING, AUSTIN, TX (US)

Correspondence Address: IBM CORPORATION;INTELLECTUAL PROPERTY LAW, 11400 BURNET ROAD, AUSTIN, TX, 78758, US

(21) Appl. No.: 11/423,714

(22) Filed: Jun. 13, 2006

(51) Int. Cl. G06F 9/44

(52) U.S. Cl. 717/101; 717/120

(57) ABSTRACT

Individual developers of source code in a shared programming system are enabled to continue to use non-essential format elements peculiar to the respective developer in their source code without any affect on the basic source code of the computer program being developed. The developer computer is connected via server computers to a central repository containing the basic shared program being developed. A server computer is provided for transmitting source code between the client computer of a developer and the central repository. There is an implementation for removing the non-essential formatting elements from source code transmitted from the client computer of the developer to the central repository, and for replacing the non-essential formatting elements into source code transmitted from the central repository to the developer's client computer.

### TECHNICAL FIELD

The present invention relates to shared computer program development and particularly to the creation of common source code by such developers.

### BACKGROUND OF RELATED ART

The last generation has been marked by a technological revolution driven by the convergence of the data processing and consumer electronics industries together, with the explosion of the World Wide Web (Web) or Internet. As a result, extraordinary worldwide communication channels and resources have become available to businesses, and this has forever changed how many businesses and industries develop software products, as well as the time cycles of such product development. Over its first forty years prior to the 1980's, the software development environment was one in which an individual or a small dedicated group willing to put in long hard hours could create “elegant” software or “killer applications” directed to and effective in one or more of the limited computer system environments existing at the time. Unlike hardware or industrial product development, the development of software did not require substantial investment in capital equipment and resources. Consequently, in the software product field, the business and consumer marketplace to which the software is directed has traditionally expected short development cycles from the time a computer need and demand became apparent to the time that a commercial software product fulfilling the need became available. Unfortunately, with the explosion of computer usage and the resulting wide diversity of computer systems that must be supported by, or at least not incompatible with, each newly developed computer software product, the development cycles have become very complex. Even when the software product development is an upgrade of an existing product, every addition, subtraction or modification of the program could have an insignificant or a profound effect on another operating system or application program that must be supported.

These great and complex requirements in computer program development, together with ease of communication between locations, has resulted in the extensive use of multiple program developers who share functions in the development of computer programs. One major example of such a shared program development system is CVS (Concurrent Versions System) that is an open-source network transparent version control system that allows multiple developers to view and edit code simultaneously. The system involves a server-client function that permits operation over the Internet or Web (these two terms are used interchangeably herein). CVS and similar systems maintain a single master copy of the source code of the program under development or change and a record of who initiated the changes, as well as when the changes were made at a central repository accessible through the Internet. The CVS program development system is available to all major computer operating systems including Unix, Linus, Mac and Windows.

It follows that since the source code is being developed by many diverse and widespread developers, extensive sets of rules and restrictions must be required of the many and diverse developers in order to develop a single universal master copy. It is recognized that rules and requirements tend to stifle creativity. Accordingly, the present invention tries to loosen these requirements, giving the individual shared computer developers some additional freedom in formatting.

### SUMMARY OF THE PRESENT INVENTION

The present invention provides the individual developers of shared program development with some exclusions to the strict requirements for shared source code development. The invention permits individual developers to continue to use non-essential format elements peculiar to the respective developer in their source code. The invention enables this in an operation completely transparent to the individual developer so that the developer may continue to use such elements in an unimpeded process.

Accordingly, the present invention is directed to a computer controlled network of client computers connected via server computers, a central repository, and provides a system for shared computer program development that comprises means for developing source code by a program developer including elements essential to a shared computer program and non-essential formatting elements peculiar to the program developer at each of a plurality of the client computers, and means for storing a basic or master copy of the shared computer program being developed at the central repository. A server computer is provided for transmitting source code between the client computer of a developer and said central repository. There are also means for removing the non-essential formatting elements from source code transmitted from the client computer of the developer to the central repository, and means for replacing the non-essential formatting elements into source code transmitted from said central repository to the client computer of the developer. The means for removing and replacing these non-essential elements are preferably in the server, but these elements may also be set up in the client computer of the individual program developer.

The removal and replacement of the non-essential formatting elements peculiar to the individual developer may be set up in a developer profile that may be stored in the server or in the computer of the developer. The latter is appropriate in the case where the means for removal and replacement are also in this client computer.

### BRIEF DESCRIPTION OF THE DRAWINGS

The present invention will be better understood and its numerous objects and advantages will become more apparent to those skilled in the art by reference to the following drawings, in conjunction with the accompanying specification, in which:

FIG. 1 is a diagrammatic general view of a network of a plurality of client computers, each used by a program developer for the shared development of programs on a source operating system platform communicating over the Web with a central repository for storing a master copy of the source code under development;

FIG. 2 is a block diagram of a data processing system including a central processing unit and network connections via a communications adapter that is capable of functioning as any of the developer computers or any of the intermediate servers in FIG. 1;

FIG. 3 is an illustrative flowchart describing the setting up of the process of the present invention for the removal/replacement of non-essential formatting elements peculiar to the developer from the source code in the master copy at the central repository; and

FIG. 4 is a flowchart of an illustrative run of the process setup in FIG. 3.

### DETAILED DESCRIPTION OF THE PREFERRED EMBODIMENT

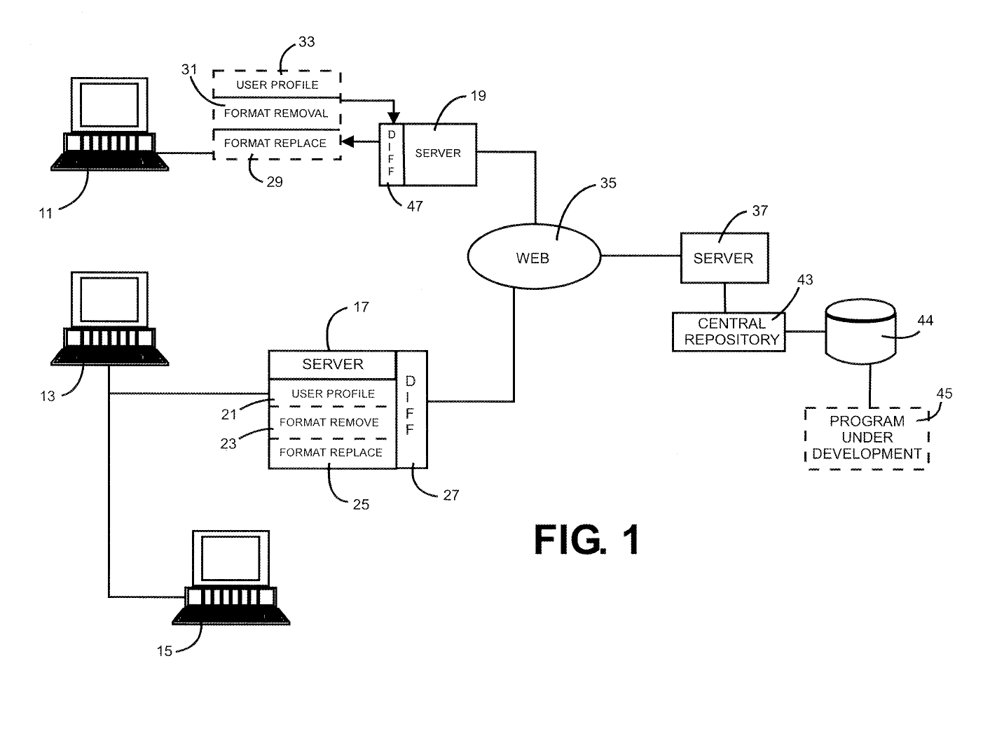

Referring to FIG. 1, a diagrammatic general view of a network of a plurality of client computer stations, 11, 13 and 15, each used by computer program developers for sharing the development of program source code for the basic or master program under development or change. These client computers are respectively connected to servers 19 and 17, which, in turn, are connected via a network, e.g. Web 35, to a central repository 43 through an appropriate server 37. The basic or master copy of the computer program 45 is stored in the central repository 43 in the form of source code in an appropriate database 44. In the server 17, supporting developers at client computers 13 and 15, a comfortable and familiar interface at the client is provided for the respective developer by a routine 23 that removes non-essential formatting elements peculiar to the respective developer from any developed source code being sent from the developer's client computer via server 17 to central repository 43. The server also has a routine 25 that replaces the non-essential formatting elements peculiar to the respective developer from any source code being sent to the developer's client computer via server 17 from central repository 43. In this manner, the removal of such programming elements non-essential to the master program source code so that the source code may be worked on prior to being integrated in the master copy in the central repository is accomplished in a manner completely transparent to the developer who just sees the full program source code with all of his non-essential programming elements at his client computer 13, 15 interface. These non-essential formatting elements, peculiar to the developer, are determined, set up and stored in a user profile 21, which is stored for each program developer at server 17. These non-essential formatting elements are removed from the source code in server 17 prior to any conventional difference (Diff), operation 27 is carried out in server 17 that determines source code change or any conventional beautification operation (not shown) is carried out.

Alternatively, as is the case with client computer 11, the format removal routine 31 and the format replacement routine 29 may be stored at the developer's client computer together with the developer's profile 33 so that these removal/replacement steps with respect to non-essential formatting elements may be carried out on the source code at the client. However, this likewise is carried out respectively before or after conventional Diff operation 47 is carried out at server 19.

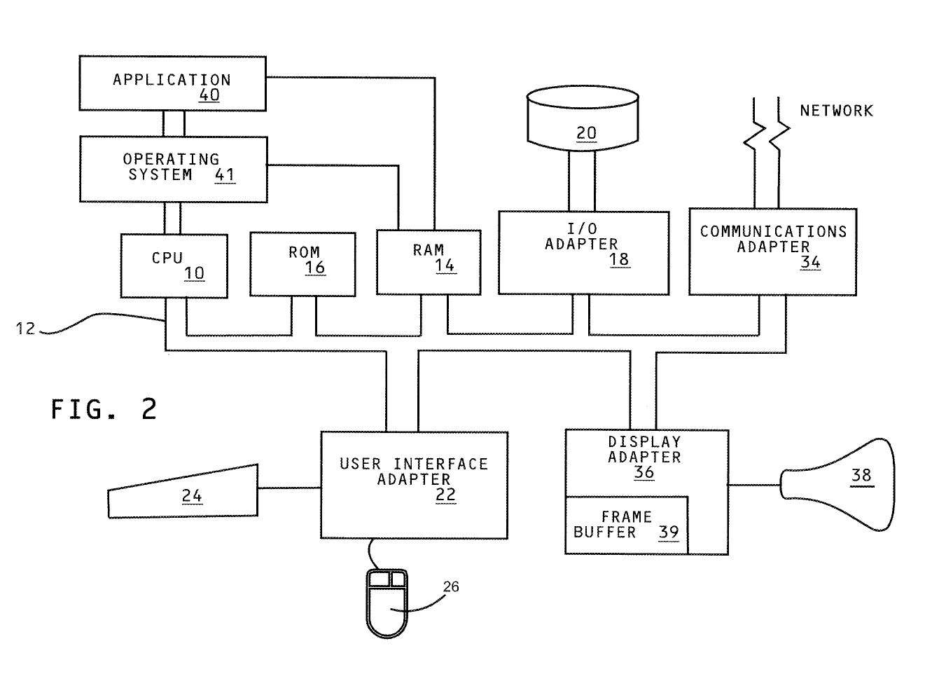

FIG. 2 is a block diagram of a data processing system including a central processing unit and network connections via a communications adapter that is capable of functioning as one of the developer client computers 11, 13 or 15 (FIG. 1) or any of the servers 17, 19 or 37 shown in FIG. 1. A central processing unit (CPU) 10, such as one of the PC microprocessors or workstations, e.g. RISC System/6000™ series available from International Business Machines Corporation (IBM), or Dell or Lenovo PC microprocessors, is provided and interconnected to various other components by system bus 12. An operating system 41 runs on CPU 10, provides control and is used to coordinate the function of the various components of FIG. 1. Operating system 41 may be one of the commercially available operating systems, such as IBM's AIX 6000™ operating system or Microsoft's WindowsXP™ or Windows2000™, as well as UNIX and other IBM AIX operating systems. Application programs 40, controlled by the system, are moved into and out of the main memory Random Access Memory (RAM) 14. These programs, in the appropriate servers or client computers include the routines of the present invention for removing non-essential formatting elements peculiar to the developer from source code being sent to the master copy of the code in a central repository that will hereinafter be described in greater detail. A Read Only Memory (ROM) 16 is connected to CPU 10 via bus 12 and includes the Basic Input/Output Systems (BIOS) that controls the basic computer functions. RAM 14, I/O adapter 18 and communications adapter 34 are also interconnected to system bus 12. I/O adapter 18 may be a Small Computer System Interface (SCSI) adapter that communicates with the disk storage device 20. Communications adapter 34 interconnects bus 12 with the outside network. I/O devices are also connected to system bus 12 via user interface adapter 22 and display adapter 36. Keyboard 24 and mouse 26 are all interconnected to bus 12 through user interface adapter 22. It is through such input devices that the user may interactively relate to the programs of this invention. In the computers or servers having a display, there is a display adapter 36 including a frame buffer 39 that is a storage device that holds a representation of each pixel on the display screen 38. Images may be stored in frame buffer 39 for display on monitor 38. By using the aforementioned I/O devices, a user is capable of inputting information to the system through keyboard 24 or mouse 26 and receiving output information from the system via display 38.

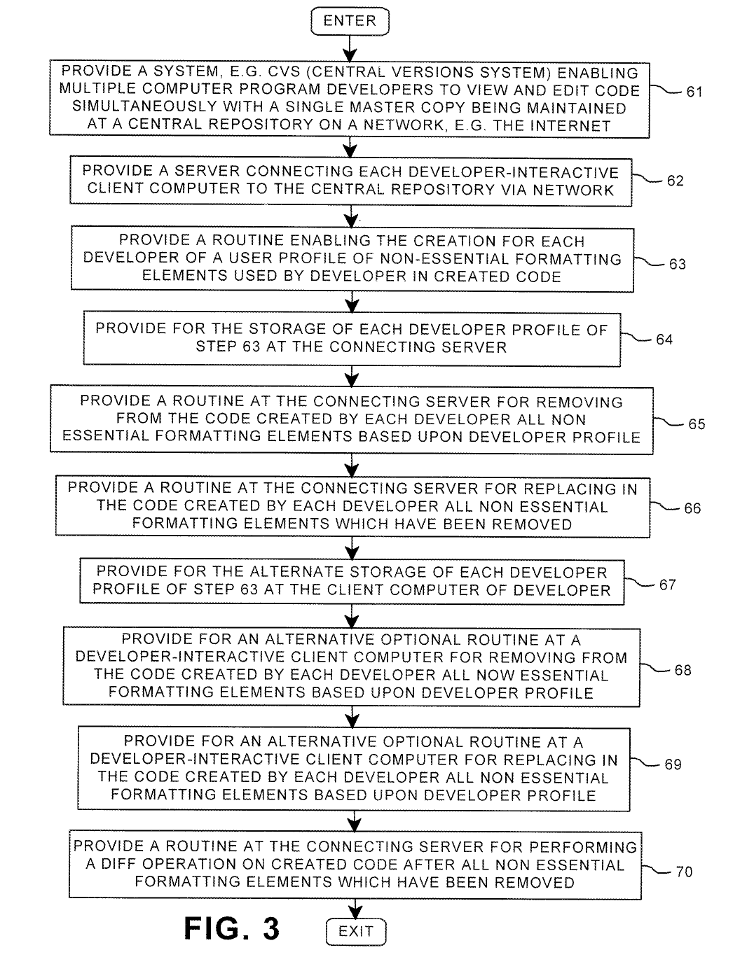

Now, with reference to FIG. 3, there will be described a process implemented by a program according to the present invention for removing non-essential formatting elements peculiar to the developer from source code being sent to the master copy of the source code in a central repository. There is provided a system, such as CVS enabling multiple computer program developers to view and edit code simultaneously with a single master copy being maintained in a central repository accessible via a network, such as the Web, step 61. There is provided a server connecting each developer-interactive client computer to the central repository via the network, step 62. There is provided a routine enabling the creation for each developer of a user profile of non-essential formatting elements of the user by the developer in the created code, step 63. There is provided for the storage of these developer profiles at the connecting servers, step 64. There is provided a routine at the connecting server for removing from the source code created by each developer, all non-essential formatting elements based upon the stored developer profile, step 65. There is also provided at the connecting server, a routine for replacing in the source code transmitted back to each developer, all non-essential formatting elements based upon the stored developer profile, step 66. Alternatively, there is provision for the storage of each developer profile at the client computer of the developer, step 67. In such a case, there may be alternative provision for a routine at the developer client computer for removing from the code created by each developer, all non-essential formatting elements based upon the stored developer profile, step 68. Likewise, there may be alternative provision for a routine at the developer client computer for replacing into the code transmitted from the central repository to each developer, all non-essential formatting elements based upon the stored developer profile, step 69. If a Diff or like operation is to be performed on the source code, then such a routine must be performed on the created source code after all non-essential formatting elements have been removed, step 70.

Non-essential format source code program elements have been discussed above. The following is an illustrative example of such elements:

Assume that the guidelines for the developer require that control statements are to format code:

```
“if (boolean)
  {
  }”.
```

However, the developer prefers to use:

“if (boolean){
}”.

In this case, in a Diff operation, when the source code control system copy or master copy would be compared to the developer's copy, the Diff tool would read these two blocks as being different, and there would be ensuing difficulties in correlation.

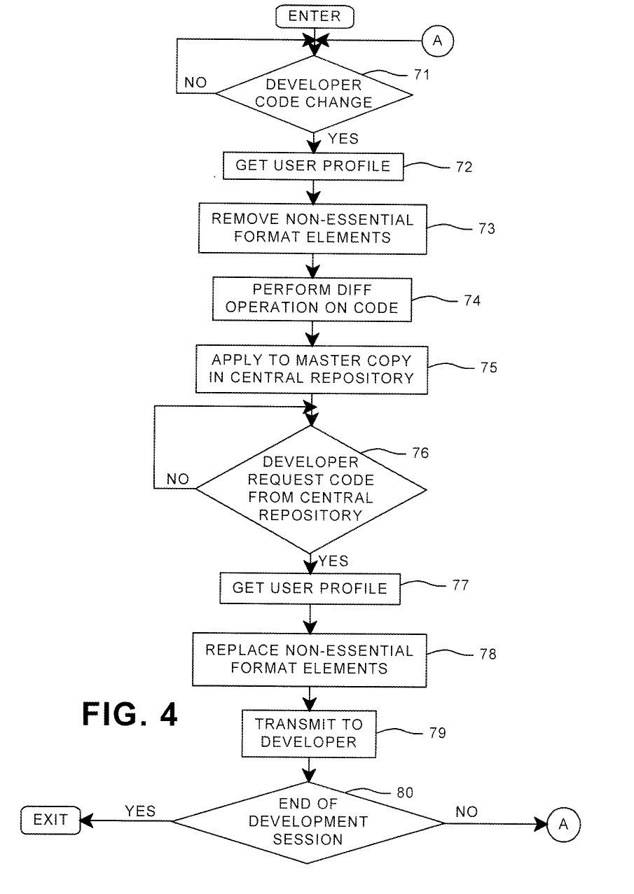

The running of the process set up in FIG. 3 will now be described with respect to the flowchart of FIG. 4. A computer program developer is working on his respective client computer. An initial determination is made as to whether there is to be a code change, step 71. If Yes, the user profile is fetched, step 72, and all non-essential formatting elements are removed from the source code, step 73. A conventional Diff operation is now performed on the source code, step 74. The developed source code is then transmitted and entered into the master program at the central repository, step 75. At any point in the operation, a determination is made, step 76, as to whether a developer at a client station has requested source code from the central repository. If Yes, the user profile is fetched, step 77, and all non-essential formatting elements are now replaced into the source code, step 78. The source code is then transmitted to the developer's client computer wherein the developer interfaces with all of his comforting formatting elements, step 79. At this point, a determination may conveniently be made as to whether the development session is to be ended, step 80. If Yes, the session is exited. If No, the process is returned to step 71 via branch “A”.

Although certain preferred embodiments have been shown and described, it will be understood that many changes and modifications may be made therein without departing from the scope and intent of the appended claims.

What is claimed is:

1. In a computer controlled network of client computers connected via server computers to a central repository, a system for shared computer program development comprising:
means for developing source code by a program developer including elements essential to a shared computer program and non-essential formatting elements peculiar to said program developer at each of a plurality of said client computers;
means for storing a basic copy of said shared computer program being developed at said central repository;
a server computer for transmitting source code between the client computer of a developer and said central repository;
means for removing said non-essential formatting elements from source code transmitted from said client computer of said developer to said central repository; and
means for replacing said non-essential formatting elements into source code transmitted from said central repository to the client computer of said developer.

2. The network of claim 1 wherein said means for removing and said means for replacing are in the client computer of said developer.

3. The network of claim 1 wherein said means for removing and said means for replacing are in said server computer.

4. The network of claim 2 further including means for storing at said client computer a program developer profile defining the non-essential formatting elements peculiar to said program developer at said client computer.

5. The network of claim 3 further including means for storing at said server computer a program developer profile defining the non-essential formatting elements peculiar to said program developer at said client computer.

6. The network of claim 2 further including means, operative subsequent to said means for removing, for performing a Diff operation on said source code.

7. The network of claim 3 further including means, operative subsequent to said means for removing, for performing a Diff operation on said source code.

8. In a computer controlled network of client computers connected via server computers to a central repository, a method for shared computer program development comprising:
developing source code by a program developer including elements essential to a shared computer program and non-essential formatting elements peculiar to said program developer at each of a plurality of said client computers;
storing a basic copy of said shared computer program being developed at said central repository;
transmitting source code between the client computer of a developer and said central repository via a server computer;
removing said non-essential formatting elements from source code transmitted from said client computer of said developer to said central repository; and
replacing said non-essential formatting elements into source code transmitted from said central repository to the client computer of said developer.

9. The method of claim 8 wherein said steps of removing and replacing are carried out in the client computer of said developer.

10. The method of claim 8 wherein said steps of removing and replacing are carried out in said server computer.

11. The method of claim 9 further including the step of storing at said client computer a program developer profile defining the non-essential formatting elements peculiar to said program developer at said client computer.

12. The method of claim 10 further including the step of storing at said server computer a program developer profile defining the non-essential formatting elements peculiar to said program developer at said client computer.

13. The method of claim 9 further including the step of performing a Diff operation on said source code subsequent to said removing step.

14. The method of claim 10 further including the step of performing a Diff operation on said source code subsequent to said removing step.

15. A computer program having code recorded on a computer readable medium for shared computer program development in a computer controlled network of client computers connected via server computers to a central repository comprising:
means for developing source code by a program developer including elements essential to a shared computer program and non-essential formatting elements peculiar to said program developer at each of a plurality of said client computers;
means for storing a basic copy of said shared computer program being developed at said central repository;
a server computer for transmitting source code between the client computer of a developer and said central repository;
means for removing said non-essential formatting elements from source code transmitted from said client computer of said developer to said central repository; and
means for replacing said non-essential formatting elements into source code transmitted from said central repository to client computer of said developer.

16. The computer program of claim 15 wherein said means for removing and said means for replacing are in the client computer of said developer.

17. The computer program of claim 15 wherein said means for removing and said means for replacing are in said server computer.

18. The network of claim 17 further including means for storing at said server computer a program developer profile defining the non-essential formatting elements peculiar to said program developer at said client computer.

19. The computer program of claim 16 further including means, operative subsequent to said means for removing, for performing a Diff operation on said source code.

20. The computer program of claim 17 further including means, operative subsequent to said means for removing, for performing a Diff operation on said source code.
